(19) United States
(12) Patent Application Publication
(10) Pub. No.: US 2012/0037657 A1
(43) Pub. Date: Feb. 16, 2012

(54) Method for Discontinuously Emptying a Container

(75) Inventor: Cosimo Mazzotta, Ulm (DE)

(73) Assignee: Daimler AG, Stuttgart (DE)

(21) Appl. No.: 13/259,984

(22) PCT Filed: Mar. 12, 2010
(86) PCT No.: PCT/EP2010/001584

§ 371 Date: Oct. 19, 2011

(30) Foreign Application Priority Data
Mar. 25, 2009 (DE) 10 2009 014 744.6

(51) Int. Cl. B67D 7/06

(52) U.S. Cl. 222/1; 222/64

(57) ABSTRACT

A method serves for discontinuously emptying a container in which liquid collects. The container is emptied via a valve or other such emptying device. The container must never be completely emptied and never overflow. A sensor is arranged in the container to detect a first state in which liquid is present in a predetermined region and a second state in which no liquid is present in the predetermined region. The valve or other emptying device is activated as soon as the sensor detects the first state, and is stopped as soon as the sensor detects the second state.

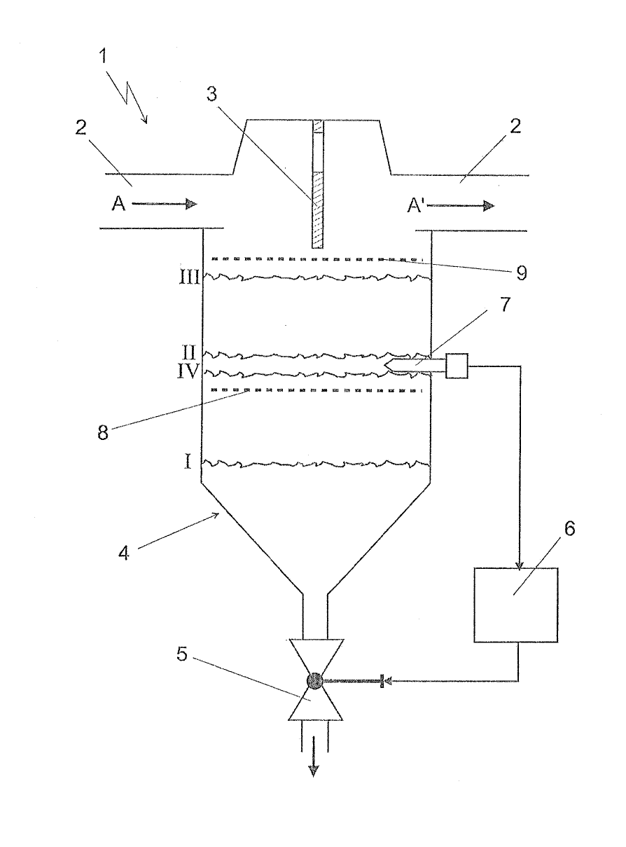

### BACKGROUND AND SUMMARY OF THE INVENTION

The invention relates to a method for discontinuously emptying a container in which liquid collects via a valve or equivalent structure.

Containers in which liquid collects and which must be emptied from time to time are known in the art. Reference can be made in this connection for example to liquid separators which typically separate liquids carried along by gas flows, for example in the form of droplets, from the gas flow. The separated liquid collects in a container of the liquid separator. From time to time, this liquid must be emptied in order to prevent overflowing of the container. Particularly when the liquid is separated from gases which may not be discharged to the environment for safety reasons, the discontinuous emptying of the container must take place so that the container does not overflow in order to avoid transporting liquid back into the gas flow and so that the container is never completely emptied upon emptying in order to always leave a certain residual amount of liquid in the container. This residual amount of liquid then serves as a barrier for retaining the gases that cannot escape to the environment.

An example application for such containers is in chemical systems in which the gases are solvents. A further application could be for use in a fuel cell system, in which such liquid separators are used in order to separate the product water produced by the fuel cell from the waste gases of the fuel cell. As the waste gases on the anode side typically contain at least a residual amount of hydrogen, it must be ensured that this hydrogen does not reach the environment. It is thus known from the general prior art to equip such containers with fill level sensors. Typically, two fill level sensors are used in order to be able to keep the fill level of the container between two such sensors. Alternatively, one fill level sensor can be used when it has two switching points, so that it is known whether the liquid level passes the fill level sensor in the direction of gravity from top to bottom, during emptying, or in the opposite direction, during filling. A disadvantage with these types of sensors is that they require comparatively high resources and are expensive. It would thus be desirable to realize a structure which facilitates reliable operation for emptying such a container with fewer and/or simpler sensors.

Float switches are also known from the prior art as fill level sensors for containers. A fill level sensor is described, for example, in U.S. Pat. No. 3,555,221, which correspondingly controls an outlet valve. The fill level sensor itself is thereby formed as a float element which controls output of liquid from the container via appropriate switching means. A similar structure in which a subsequent fill pump holds a fill level in a container at a predefined level is described, for example, in U.S. Pat. No. 5,010,218. A float element is also used here to detect the fill level.

Besides float switches as sensors, capacitive sensors are also known from the further general prior art which output different electric signals depending upon whether a region of their surface is in contact with liquid or not. In comparison with the mechanical structure of the float elements, these sensors have the advantage of a simple mechanical structure which is nowhere near as prone to failure as a float element which can tilt in a housing and would thus display false values.

It is the object of the present invention to create a method for discontinuously emptying a container in which liquid collects, so that it can be guaranteed, with minimum resources in relation to the sensors, that the container both never overflows and is never completely emptied.

According to the invention this object is achieved through the claimed features. Further advantageous embodiments of the invention are also claimed.

The emptying means for the container is always activated in the inventive method when the sensor detects the first state, and thus when liquid is present in the predetermined region. As soon as the sensor detects the second state, no further liquid is present in the predefined region, and the emptying means is stopped. The emptying means according to the invention can be a valve which is arranged so that in the open state it empties the container with the aid of gravity and/or a pressure inside the container. Alternatively, however, other means would also be conceivable, for example a pump for emptying the container.

With a single sensor which has merely one switching point, a reliable discontinuous emptying of the container can be achieved. A certain hysteresis effect inherent in the system is used for this. If liquid is present in the region of the sensor, the emptying means is activated; thus for example a valve is opened, or an emptying pump is activated. Due to the fact that both a valve and also a pump as an emptying means are mechanical components which have a certain reaction time and that the emptying means is connected to the container via corresponding line sections or volumes, a certain delay arises between the detection of the state by the sensor and the start of activation of the emptying means or the stopping of the activation of the emptying means. If the liquid level thus passes the sensor, the activating means is correspondingly then stopped. However, a certain time passes until the mechanical stop of the emptying means arises and the emptying actually ends. During this time the emptying continues so that a liquid level is reached with the stop of the emptying means which lies below the sensor.

If further liquid has now entered the container, the liquid level increases again. From a certain point it will reach the sensor which in turn switches from the state without liquid to the state with liquid. This will in turn trigger a new activation of the emptying means. This is also encumbered with a certain delay due to the system, so that the liquid level in the container increases further beyond the sensor until the actual activation of the emptying means starts. From this point in time the process begins again.

According to a particularly favourable embodiment of the invention, the distances between the emptying means and the sensor are selected so that in the delay caused by the system until the actually stopping of the emptying means the emptied volume is smaller than the volume in the container between the region of the sensor and the region of the emptying means. It can thereby be ensured that the container is never completely emptied.

In a further particularly favourable embodiment of the invention it is further provided that the distance between a region of the container in which it overflows and the sensor is also formed to be correspondingly large so that the subsequent running of liquid into the container takes place as a maximum so fast that the emptying means is already activated after the sensor has reported the change of state before the container overflows.

With this structure, safe and reliable operation of the method for discontinuously emptying the container can thus be realized. For this, a single sensor which comprises merely one switching point is sufficient.

According to a particularly favourable embodiment of the invention it is further provided that the time which passes from the detection of the change of state until the activation of the emptying means is changed over a predefined time delay.

Particularly when the possibility exists of using a rather large container in comparison with the volume of liquid arising, this can be decisively advantageous as a frequent switching of the emptying means can be correspondingly prevented. In particular, the variation of time also offers the possibility of integrating the system into existing containers. as through a corresponding adjustment of the time, for example in a test operation under extreme conditions, a reliable operation can be achieved without having to change the construction of the container itself.

In a further particularly advantageous embodiment of the inventive method it is further provided that a capacitive sensor is used as the sensor. In comparison with other fill level sensors, such as for example float switches, such a capacitive sensor, which is known in principle from the prior art, offers the advantage that it has a simple construction and manages without corresponding mechanical means. It can thus detect a change in state comparatively simply and reliably even under extreme conditions.

According to a particularly favorable embodiment of the invention, it is further provided that the sensor and/or the container is provided with means for damping a sloshing around of the liquid. With this structure, wherein the sensor is inserted for example into a corresponding immersion pipe, or in that elements for reducing sloshing of the liquid which are known in themselves are provided in the container, it can be ensured that the sensor does not detect a change of state due to a liquid sloshing against it which could lead to a corresponding malfunction of the system, as the liquid level assumed by the sensor has been caused merely by sloshing and as such does not exist. Besides mechanical means electronic means would also be conceivable which typically detect a reaction of the sensor to sloshing as typical for sloshing and filter it out.

A further particularly favorable and advantageous embodiment of the inventive method provides that the container is used as a liquid separator. In particular this can be used according to an advantageous development as a liquid separator in a fuel cell system. In such a fuel cell system corresponding quantities of product water arise together with the waste gases from the fuel cell both in the anode waste gas and in the cathode waste gas. Particularly in the anode waste gas the liquid separator must function safely and reliably as overflowing of the liquid would allow this to go back into the fuel cell system. The liquid could block corresponding gas channels or similar there and/or wet them and impair the functionality of the system in the long term. On the other hand it is important that no waste gas itself reaches the environment as this is typically hydrogen or at least comprises a residual portion of hydrogen. This hydrogen should not reach the environment for safety reasons alone in order to suppress possible risks having regard to combustion or explosion.

In a particularly favorable further development of the method it can thereby be provided that the fuel cell system is used to generate electrical energy in a transport means. The electrical energy can thereby serve to drive the transport means and/or for the operation of subsidiary or auxiliary units in the transport means. Particularly when using the fuel cell system in a transport means such as for example a motor vehicle, a heavy goods vehicle, a floor conveyor, an aircraft, a ship or similar it is of decisive importance that the liquid separators function safely and reliably. Due to the limited construction space in a transport means the fuel cell system and in particular the liquid separators can thereby not be constructed in any desired size. With correspondingly small liquid separators the two abovementioned problems of overflowing and discharge of gas to the environment are particularly critical, however, as correspondingly small containers of the liquid separators require frequent discontinuous emptying. The inventive method is thus particularly advantageous in such applications as the highest safety requirements must be realized here besides a very safe and reliable functionality with greatly restricted construction space.

Further advantageous embodiments of the inventive method follow and are set out below by reference to the embodiment that is explained by reference to the drawing.

### BRIEF DESCRIPTION OF THE DRAWINGS

The single drawing shows a schematically represented liquid separator.

### DETAILED DESCRIPTION OF THE INVENTION

The drawing shows a schematically represented liquid separator 1, as can be used for example in a fuel cell system in a vehicle. The liquid separator 1 is arranged for this application in particular in the region of the cathode waste gas and/or the anode waste gas and separates liquid product water from the region of these waste gases. This is to be symbolized here through the line element 2, in which—as indicated by the arrow A—a gas is to flow together with condensed liquid. The gas then leaves the liquid separator 1 as gas A′ without liquid components. The liquid is correspondingly separated in the region of a baffle plate 3 while the gas A flows by this baffle plate 3 and/or undergoes a change in direction. The structure with the baffle plate is thereby selected purely by way of example. All other types of separating mechanisms can also be realized, for example a circulating gas flow, wherein the liquid particles are expelled outwards. This is of less importance, however, for the invention shown here so that here for example a variant of a liquid separator 1 with a baffle plate 3 has been shown.

The liquid separator 1 comprises a container 4, in which the separated liquid collects. The container 4 can be emptied in the direction of gravity downwards through a valve 5 as an emptying means. The valve 5 is thereby controlled via an electronic unit 6. The valve 5 can be formed for example as a magnetic valve which is opened to empty the container 4. The emptying of the liquid from the container 4 then takes place through the effect of gravity on the liquid and/or through a driving pressure gradient in the gas A, A′ in relation to the environment, as the gas A, A′ is found as a gas cushion above the liquid in the container 4.

The container 4 further comprises a sensor 7 which is formed here for example as a capacitive fill level sensor 7. The sensor 7 thereby comprises merely one switching point so that merely two states can be detected by the sensor 7. The first state is a state in which liquid is present in a predetermined region. This means for example that the sensor 7 is wetted with liquid, and the liquid level in the container 4 has thus exceeded at least the height of the sensor 7. A second state which can be detected by the sensor 7 consists in that in the predetermined region no liquid is present, and the sensor 7 is thus dry in the example set out above, as the fill level of the liquid in the container 4 lies below the sensor.

By way of example four such liquid states are shown in the single drawing. A first liquid state with the designation I is located in the container 4 below the sensor 7. The sensor 7 is thus then located in the second state and will send a corresponding signal to the electronic unit 6 so that it can be determined via the electronic unit 6 that in the region of the sensor 7 no liquid is present. The second liquid level II illustrated shows the liquid in the container 4 in the region slightly above the sensor 7. In this state the sensor 7 is wetted with liquid so that the sensor 7 will send a corresponding signal for the second state to the electronic unit 6. The third illustrated state which has the designation III shows a liquid level in the container 4 above the sensor 7. Also in this state the sensor 7 will detect the state with liquid. The fourth fill level IV lies in turn slightly below the sensor 7 so that this will again detect the second state and report to the electronic unit 6.

The container 4 of the liquid separator 1 further comprises an anti-sloshing means 8 which is shown here by way of example as a perforated plate which is arranged in a region slightly below the sensor 7 transversely to the opening of the container. Such an anti-sloshing means 8 prevents sloshing up of the liquid upon movement of the liquid separator 1, as can arise for example in use in transport means such as for example motor vehicles. Through the anti-sloshing means 8 a wetting of the sensor and thus an erroneous detection can be extensively prevented. Besides the anti-sloshing plate 8 shown here by way of example the anti-sloshing means can obviously also have a different design. For example the sensor can be built into a corresponding pipe, which is formed through correspondingly small openings so that liquid does not completely penetrate into the pipe upon sloshing up but upon reaching the corresponding fill level floods the pipe completely in order to be able to detect a corresponding fill level through the sensor 7. Besides or additionally a filter can be provided in the electronic unit 6 which recognises signals typical for sloshing on the sensor 7 and filters them out of the usable signals of the sensor 7.

In the only drawing a further exemplary anti-sloshing means 9 can be seen. This is intended to prevent liquid sloshing into the region of the lines 2. As such devices for anti-sloshing protection are also known in principle from the prior art these structures will not be described in greater detail here but instead only an example variant will be explained in brief It is thereby clear to the person skilled in the art that all other conceivable variants of an anti-sloshing means, in particular a mechanical anti-sloshing means, can be integrated correspondingly into the container 4.

The process for discontinuous emptying of the container 4 is now as follows:

The liquid separated from the moist gas flow A will collect in the container 4. With an increasing quantity of separated liquid this will reach the liquid level with the designation II at some time. In this case the sensor 7 will ascertain the first state, thus report to the electronic unit 6 that in a predetermined region liquid is present around the sensor 7. The electronic unit 6 will control the valve 5 correspondingly so that the container 4 can be emptied via the valve means 5. As a certain time will elapse, however, from the detection of the liquid level II until the actual activation of the valve 5 which is necessary for the detection and control of the valve 5 the liquid level in this time will increase further, for example to the liquid level with the designation III. Only then is the valve 5 completely opened and the container 4 can be emptied. The opening for emptying is thereby to be selected in each case so that the volume flow flowing away upon emptying is always greater than the liquid flow into the container. In addition it is to be ensured through a corresponding positioning of the sensor 7 and/or the constructive design of the container that the volume between the sensor 7 and the fill level III is so great that all liquid arising as a maximum in this period can be stored within the volume without the container 4 overflowing and liquid reaching the region of the line elements 2.

After the liquid level has now reached the fill level III the emptying via the valve 5 will begin. With the start of emptying the liquid level falls starting from the fill level III back to the fill level IV. At this fill level IV slightly below the sensor 7 the latter will in turn detect a change in the state and report it to the electronic unit 6. This then gives a signal to the valve 5 in order to stop the emptying, in this case thus to close the valve 5. This process also requires a corresponding time so that upon definitive closure of the valve the liquid in the container 4 has fallen for example to the state I.

It is also to be ensured here in turn that the volume between the sensor 7 and the state I is only so great that during the inevitably arising delay between the detection of the state and the switching of the valve not all liquid reaches the environment but instead a certain residual liquid remains in the container 4. This residual liquid then ensures that no gas A can pass via the valve 5 into the environment. After the liquid has reached the fill level I and the valve 5 has finally closed liquid will collect again in the container 4 so that the fill level of the liquid rises again. After a certain time it will reach the fill level II again so that the process begins from the start.

The inventive method thus allows with a single, very simply designed sensor a safe operation during discontinuous emptying of the container. The structure can thereby be constructively adapted so that on the one hand overflowing of the container 4 into the region of the lines 2 does not arise and on the other hand no gas A, A′ passes through the valve 5 to the environment. Besides the purely constructive design of the container 4 and the position of the sensor 7 this hysteresis behavior arising in principle in the system, which is used for the inventive method, can again be intensified through a corresponding change in the region of the electronic unit 6. It would thus be conceivable to incorporate a corresponding time delay in the electronic unit 6 so that the time delay between the reaction of the sensor 7 and the actual definitive activation of the valve means 5 can be correspondingly adapted. By means of such a time element an adaptation to constructively arising tolerances could be achieved. Or the inventive method could be subsequently fitted in existing containers 4 as through an individual adaptation of a delay in the electronic unit 6 the system can be adapted to any structural forms which offer an adequate distance between the sensor 7 and the valve means 5 on the one hand and the senor 7 and the upper edge of the container 4 on the other hand. It is thereby also possible to select the time delay to be longer in one direction, e.g. during filling, than in the other direction, e.g. during emptying. The necessity for a special constructive design of the container is thus extensively absent.

1-11. (canceled)

12. A method for discontinuously emptying a container, in which liquid collects via an emptying means, that must neither be completely emptied nor overflow, with a sensor that detects a first state in which liquid is present in a predetermined region and a second state in which no liquid is present in the predetermined region, comprising:
activating the emptying means as soon as the sensor detects the first state, and
stopping the emptying means as soon as the sensor detects the second state.

13. The method according to claim 12, wherein a distance of the sensor from a region in which the emptying means is arranged is so great that the volume in this region is greater than a volume which is emptied in a time that passes from detection of a change in state until activation of the emptying means.

14. The method according to claim 12, wherein a distance of the sensor from a region in which the container overflows is so great that the volume in this region is greater than a maximum volume of liquid collecting in a time that passes from detection of a change in state until activation of the emptying means.

15. The method according to claim 12, wherein the time which passes from the detection of the change of state until the activation of the emptying means is changed over a predefined time delay.

16. The method according to claim 12, wherein a fill level sensor with a switching point is used as the sensor.

17. The method according to claim 12, wherein a capacitive sensor is used as the sensor.

18. The method according to claim 12, wherein a valve is used as the emptying means.

19. The method according to claim 12, wherein at least one of the sensor and the container is provided with means for damping a sloshing of the liquid.

20. The method according to claim 12, wherein a liquid separator is used as the container.

21. The method according to claim 20, wherein the liquid separator is used as a liquid separator in a fuel cell system.

22. The method according to claim 21, wherein the fuel cell system is used to generate electrical energy in a transport means.
